(19) United States
(12) Patent Application Publication
(10) Pub. No.: US 2018/0373274 A1
(43) Pub. Date: Dec. 27, 2018

(54) DIAPHRAGM REGULATOR FOR HIGHER PRESSURE INPUT GAS

(71) Applicant: Walbro LLC, Tucson, AZ (US)

(72) Inventors: Tomoya Kawada, Sendai-city (JP); Naoya Kumagai, Iwanuma-City (JP)

(21) Appl. No.: 16/018,902

(22) Filed: Jun. 26, 2018

Related U.S. Application Data
(60) Provisional application No. 62/525,372, filed on Jun. 27, 2017.

(51) Int. Cl. G05D 16/06

(52) U.S. Cl. CPC G05D 16/0633; G05D 16/0636

(57) ABSTRACT

In at least some implementations, a pressure regulator includes a first body, a second body coupled to the first body and a diaphragm having a portion trapped between the first body and the second body and a not trapped portion that is movable relative to the first body and second body. A stop surface is defined by the second body, and a backing member is coupled to the not trapped portion of the diaphragm for movement with the not trapped portion of the diaphragm. The backing member engages the stop surface to limit the amount the not trapped portion of the diaphragm can move toward the second body.

### REFERENCE TO RELATED APPLICATIONS

This application claims the benefit of U.S. Provisional Application Ser. No. 62/525,372 filed on Jun. 27, 2017, the entire contents of which is incorporated herein by reference in its entirety.

### TECHNICAL FIELD

The present disclosure relates generally to a fuel pressure regulator capable of handling higher pressure input gas.

### BACKGROUND

Diaphragm fuel pressure regulators utilize flexible diaphragms to actuate valves that control gas flow into and out of the pressure regulator. The diaphragm is typically trapped about its periphery between two bodies and the untrapped, central portion of the diaphragm defines part of a pressure chamber. When pressurized gas is admitted into the pressure chamber, the force of the gas acting on the diaphragm causes the diaphragm to flex in a direction tending to increase the volume of the pressure chamber. A valve is actuated by the diaphragm as the central portion of the diaphragm moves. In some pressure regulators, when a threshold pressure is reached in the pressure chamber, the valve is closed to prevent further gas from being admitted into the pressure chamber until some gas is discharged from the gas chamber. Hence, the pressure of gas discharged from the pressure regulator may be at or below the threshold pressure. Excess pressure at the valve may force the valve open and unduly flex the diaphragm, sometimes damaging the valve and/or the diaphragm.

### SUMMARY

In at least some implementations, a pressure regulator includes a first body, a second body coupled to the first body and a diaphragm having a portion trapped between the first body and the second body and a not trapped portion that is movable relative to the first body and second body. A stop surface is defined by the second body, and a backing member is coupled to the not trapped portion of the diaphragm for movement with the not trapped portion of the diaphragm. The backing member engages the stop surface to limit the amount the not trapped portion of the diaphragm can move toward the second body.

In at least some implementations, a biasing member is engaged with the second body and the backing member to yieldably bias the diaphragm away from the second body. The stop surface may be arranged so that the backing member engages the stop surface before the diaphragm is plastically deformed. The stop surface may be an annular surface that is raised or located closer to the diaphragm than portions of the second body adjacent to the stop surface.

A pressure chamber may be defined at least in part between the first body and the not trapped portion of the diaphragm, and the first body may include a groove formed in the area of the trapped portion of the diaphragm, and the diaphragm may include a bead received at least partially within the groove. The groove may have an inner side surface, a bottom surface and an outer side surface and the bead is engaged with the bottom surface and the outer side surface. The main body may include a relieved section that defines a wider portion of the groove at the outer side surface. The relieved section may include an outwardly angled section of the outer side surface. The second body may include a groove facing the diaphragm and the bead may be at least partially received within the groove in the second body. The bead may have a width that is less than the distance between the inner side surface and the outer side surface and the bead is not engaged with the inner side surface. The groove in the first body may have a bottom surface and the groove in the second body may have a bottom surface that faces the opposite direction as the bottom surface of the groove in the first body, and the bead may be compressed between the bottom surface of the first groove and the bottom surface of the second groove.

In at least some implementations, a pressure regulator includes a first body including a groove having an inner side surface, a bottom surface and an outer side surface and the bead is engaged with the bottom surface and the outer side surface, a second body coupled to the first body, and a diaphragm having a portion trapped between the first body and the second body and a not trapped portion that is movable relative to the first body and second body, the portion trapped between the first body and the second body includes a bead received at least partially within the groove. A pressure chamber is defined at least in part between the first body and the not trapped portion of the diaphragm.

In at least some implementations, the main body includes a relieved section that defines a wider portion of the groove at the outer side surface. The relieved section may include an outwardly angled section of the outer side surface. The second body may include a groove facing the diaphragm and the bead may be at least partially received within the groove in the second body. The groove in the first body may have a bottom surface and the groove in the second body may have a bottom surface that faces the opposite direction as the bottom surface of the groove in the first body, and the bead may be compressed between the bottom surface of the first groove and the bottom surface of the second groove. At least one of the groove in the first body or the groove in the second body includes a relieved section that defines a wider portion of that groove at the outer side surface. The bead may have a width that is less than the distance between the inner side surface and the outer side surface and the bead is not engaged with the inner side surface. The bead may have a width that is less than the distance between the inner side surface and the outer side surface and the bead is not engaged with the inner side surface.

It is contemplated that the various features set forth in the preceding paragraphs, in the claims and/or in the following description and drawings may be taken independently or in any combination. For example, features disclosed in connection with one embodiment or implementation are applicable to all embodiments or implementations, except where there is incompatibility of features.

### BRIEF DESCRIPTION OF THE DRAWINGS

The following detailed description of certain embodiments and best mode will be set forth with reference to the accompanying drawings, in which:

FIG. 1 is a side view of a pressure regulator;

FIG. 2 is a top view of the pressure regulator;

FIG. 3 is a cross-sectional perspective view of the pressure regulator;

FIG. 4 is a fragmentary sectional view of the pressure regulator showing a first stage diaphragm;

FIG. 5 is a top view of a diaphragm backing plate;

FIG. 6 is a bottom view of the diaphragm backing plate;

FIG. 7 is a fragmentary sectional view of the pressure regulator showing a first stage diaphragm having a peripheral sealing rim received within a groove having a relief or chamfer; and

FIG. 8 is an enlarged, fragmentary sectional view of a portion of FIG. 7 showing the rim and groove.

### DETAILED DESCRIPTION

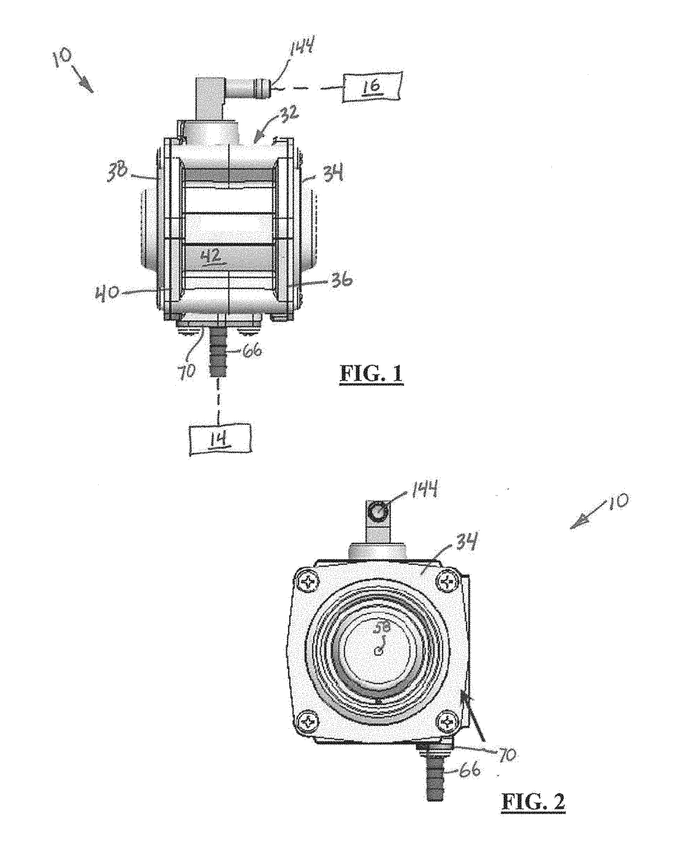

Referring in more detail to the drawings, FIGS. 1-3 illustrate one implementation of a pressure regulator 10 having a diaphragm-type pressure control system 12. Generally, the pressure regulator 10 is configured to take in gas from a fuel source 14 (e.g. tank or canister) at varying pressures and to provide an output of gas at a threshold pressure for use by a downstream device 16. In at least some implementations, the gas may be propane or other fuel gas and the downstream device 16 may be an engine in which the fuel gas is combusted to support engine operation. The pressure control system 12 includes at least one diaphragm that moves in response to pressure changes in a pressure chamber 18 to actuate a valve 20 that controls gas flow into the pressure chamber 18. In the example shown, the pressure regulator 10 includes two diaphragm assemblies—an inlet diaphragm assembly 22 controls admission of gas to a first pressure chamber 18 by way of an inlet valve 20 actuated by a first diaphragm 24, and an outlet diaphragm assembly 26 controls the discharge of gas from the pressure regulator 10 by way of a second valve 28 actuated by a second diaphragm 30.

The pressure regulator 10 includes a first body (hereafter called a main body 32), a second body (hereafter called a first cover 34) that is coupled to one side 36 of the main body 32 and a third body (hereafter called a second cover 38) coupled to a second side 40 of the main body. The first and second sides 36, 40 of the main body 32 are shown as being opposite sides of the main body (e.g. top and bottom sides) but need not be. Between the top and bottom sides 36, 40 of the main body 32, the main body 32 includes a peripheral sidewall 42 and an intermediate wall 44 that has at least a portion spaced from both the top and bottom sides 36, 40. Grooves 46, 48 are provided in the top and bottom sides 36, 40 of the main body 32 inboard of the perimeter of the sidewall 42. In at least some implementations, the grooves 46, 48 are generally U-shaped and are circumferentially continuous.

The first diaphragm 24 has a peripheral portion with a continuous bead 50 received within the groove 46 formed in the bottom side 36 of the main body 32. The bead 50 is trapped and retained in the groove 46 by the first cover 34 which overlies the first diaphragm 24 and is coupled to the main body 32 such as by one or more fasteners. The first diaphragm 24 is imperforate, at least in the area radially within and including the bead 50, and the fasteners are located outboard of the bead 50. One or more gaskets or seals may be received between the first diaphragm 24 and the main body 32, or between the first diaphragm 24 and the first cover 34, or between the cover 34 and main body 32.

The first diaphragm 24 is typically a relatively thin, flexible piece of material arranged so that a force differential across the diaphragm will cause its central portion 52, which is not trapped between the cover 34 and main body 32, to move against the direction of lower force. Any type of material that can be formed so that its movement is sufficiently sensitive to fluid pressure differentials may be used, so long as it meets other performance requirements, such as resistance to permeability with the gas with which the regulator is intended for use, fatigue strength, tear strength, etc. One example of many materials that may be used includes nitrile butadiene rubber (NBR) with a polyamide fabric such as 66 Nylon.

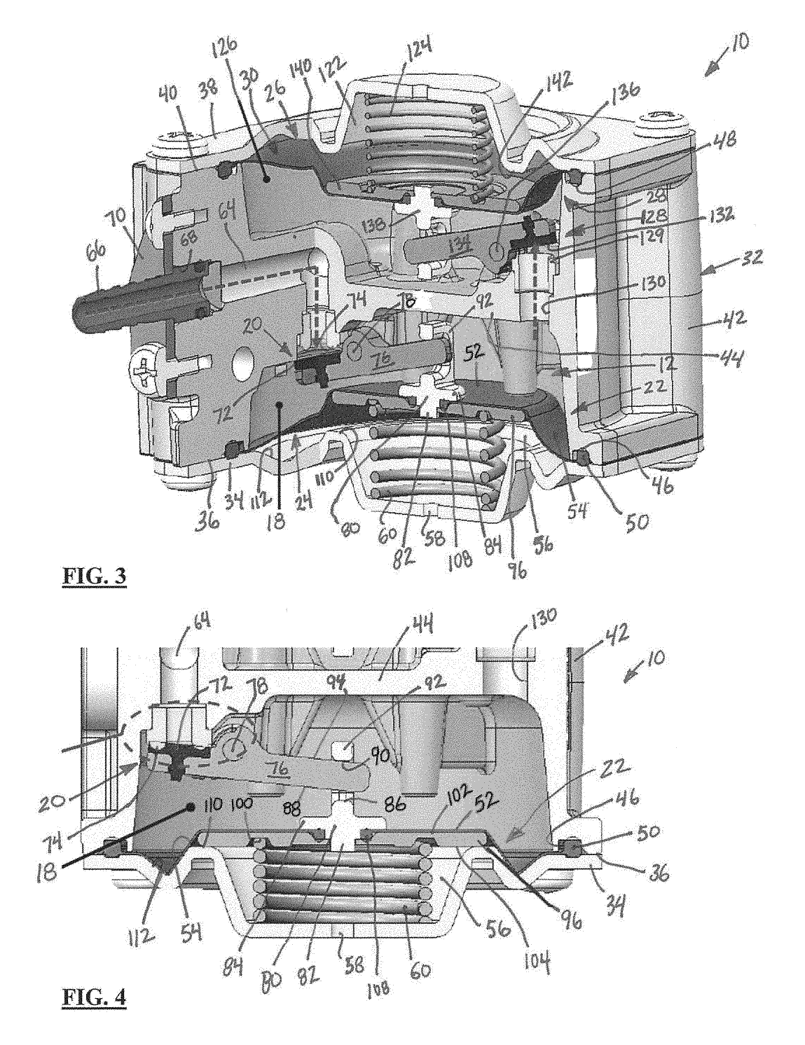

In at least some implementations, to facilitate a sufficient amount of movement of the central portion 52, the first diaphragm 24 may include a convolution 54 or non-planar region inwardly spaced from the trapped portion of the diaphragm 24 (where the trapped portion includes the bead and adjacent diaphragm portion received between the main body 32 and cover 34). In the implementation shown, the diaphragm 24 is generally frustoconical and concave as viewed from the first cover 34, convex as viewed from the intermediate wall 44 as shown in FIGS. 3 and 4. The non-planar region 54 may be molded into the first diaphragm 24 during manufacture, or it may be formed by controlled stretching of a flat piece of diaphragm material within the central portion 52. Inclusion of the non-planar region 54 causes the surface area of the untrapped or not trapped portion 52 of the first diaphragm 24 to be larger than the surface area of a plane including the area radially within the bead 50 of the first diaphragm 24. The larger the convolution 54 is (i.e., the more the amount of additional surface area), the larger the overall allowable diaphragm movement is. The non-planar region 54 may have any desired shape and size, other embodiments may include more than one non-planar region or convolution, and non-planar regions or convolutions may be located elsewhere along the first diaphragm 24.

A reference chamber 56 is defined at least in part by a first side of the first diaphragm 24 and the cover 34, and in the implementation shown, the cover includes a vent opening 58 that communicates the reference chamber 56 with the atmosphere and air within the reference chamber is then at atmospheric pressure. The reference chamber 56 could otherwise be communicated with a pressure source at a different pressure, if it is desired to have a different pressure within the reference chamber and acting on the first diaphragm 24. In addition to or instead, a biasing member (e.g. spring 60) may be provided within the reference chamber 56 and acting upon the first diaphragm 24 to provide a force yieldably opposing movement of the not trapped central portion 52 of the diaphragm 24 in a direction tending to decrease the volume of the reference chamber 56.

The pressure chamber 18 is defined at least in part by a second side of the first diaphragm 24 and the intermediate wall 44 of the main body 32. An inlet passage 64 communicates with the pressure chamber 18 to admit pressurized gas into the inlet passage as set forth below. The inlet passage 64 may be formed at least partially within the main body 32 and/or by a fitting 66 or conduit. In the example shown, a fitting 66 is received within a counterbore 68 formed in the main body 32 and is held in place by a retaining plate 70 that is secured to the main body. The fitting 66 may include outwardly extending barbs to retain a hose or conduit pressed onto the fitting, where the hose or conduit communicates a supply 14 of pressurized gas with the pressure regulator 10.

To control the admission of gas into the pressure chamber 18, the inlet valve 20 is arranged to selectively close the inlet passage 64. The inlet valve 20 includes a valve head 72 that selectively engages a valve seat 74 to close the inlet passage 64. The valve seat 74 may be part of the main body 32 or, as shown in the drawings, the valve seat may be defined by a separate component (sometimes called an insert) that is assembled to the main body before the first diaphragm 24 is installed. In at least some implementations, the valve head 72 is carried by a lever 76 that is coupled to the main body 32 by a pivot pin 78 about which the lever pivots relative to the main body. The valve head 72, lever 76 and pivot 78 may all be received within the pressure chamber 18. The valve head 72 is on an opposite side of the pivot 78 as a contact element 80 carried by the first diaphragm 24 which engages and drives the lever 76 about the pivot 78 at least during certain movements of the diaphragm 24.

In the implementation shown, the contact element 80 is a body that is formed separately from the first diaphragm 24 and then coupled to the first diaphragm within the movable, untrapped central portion 52 of the first diaphragm. The contact element 80 may include a central post 82 that extends through an opening in the diaphragm 24, and a radially outwardly extending flange 84 that overlies a portion of the second side of the first diaphragm 24. Hence, the contact element 80 moves as the central portion 52 of the first diaphragm 24 moves. The contact element 80 may be formed of a durable material and may prevent damage to the diaphragm 24 that might otherwise be caused if the diaphragm directly engaged the lever 76, which may be done in at least some implementations, if desired. In the implementation shown in FIG. 4, the contact element 80 includes a first surface 86 that engages one side 88 of the lever 76 to move the valve head 72 away from the valve seat 74 and a second surface 90 defined on a hook or finger 92 that engages the opposite side 94 of the lever 76 to move the valve head 72 toward the valve seat 74.

In use, pressurized gas is provided from a gas source 14 to the inlet passage 64. When the pressure within the pressure chamber 18 is less than a threshold, the spring 60 displaces the diaphragm 24 which engages the first surface 86 of the contact element 80 with the lever 76. This rotates the lever 76 counterclockwise (as viewed in FIG. 4) and opens the inlet valve 20 by moving the valve head 72 away from the valve seat 74. It is also noted that pressurized gas acts on the portion of the valve head 72 within the inner diameter of the valve seat 74 and provides force tending to open the valve 20, the magnitude of this force being a function of the gas pressure and the surface area on which the gas pressure acts. Pressurized gas then enters the pressure chamber 18 which increases the pressure within the chamber 18 and the force opposing the force of the spring 60 on the diaphragm 24 (and the gas pressure acting on the valve head 72). The increasing pressure within the pressure chamber 18 flexes the diaphragm 24 and moves the central portion 52 of the diaphragm toward the first cover 34. The diaphragm movement continues until the pressure within the pressure chamber 18 reaches the threshold at which pressure the first diaphragm 24 will have moved sufficiently to cause the second surface 90 of the contact element 80 to engage the lever 76 and rotate the lever to close the valve head 72 against the valve seat 74. This prevents additional pressurized gas from entering the pressure chamber 18 until the pressure within the pressure chamber 18 is reduced, as will be described later.

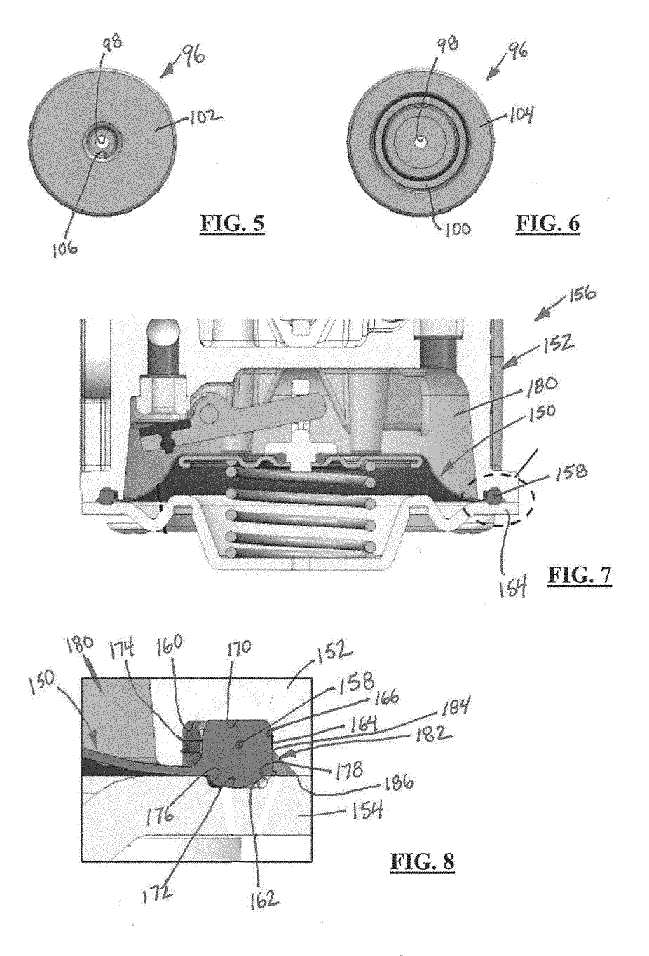

To reduce stress and forces on the diaphragm 24 from the contact element 80, the assembly 22 may include a backing member 96 which may be in the form of a disc or plate received adjacent to or against the first side of the first diaphragm 24, and including an opening 98 (FIGS. 5 and 6) through which the post 82 may extend. The post 82 may be crimpled, welded, heat staked, clipped, riveted, expanded in or about, adhered, bonded or otherwise fixed to the backing plate 96 to limit or prevent relative movement between the contact element 80, diaphragm 24 and backing plate 96. The backing plate 96 may include a groove 100 in which an end of the spring 60 may be received, the other end of the spring bearing on the cover 34 so that the spring 60 may be variably compressed between the backing plate 96 and the cover 34. Hence, the position of the spring 60 and the application of the spring force to the diaphragm 24 may be reliably controlled.

The backing plate 96 may provide some mass and rigidity to the diaphragm assembly 22 to stabilize movement of the diaphragm 24 in response to pressure differentials across the diaphragm and provide more controlled movement of the contact element 80 relative to the lever 76. Backing plate 96 may be formed from a relatively high stiffness material such as stainless steel or another metal, and may be relatively thin (e.g., between 0.4 mm and 2.5 mm thick). As shown in FIGS. 5 and 6, the backing plate 96 may be circular to avoid any peripheral sharp edges or corners that may damage the diaphragm 24, and the backing plate may be a generally flat disc with opposed, planar, and circular faces 102, 104. The first face 102 is engaged with the diaphragm 24 and may include a cavity 106 in which a portion of the contact element 80 and/or a seal 108 (FIGS. 3 and 4) may be received to provide a gas-tight seal between the contact element 80 and the backing plate 96. The second face 104 is engaged by the spring 60 and may include the groove 100 to retain one end of the spring. If desired, the backing plate 96 may include openings or cut-outs to reduce its mass and inertia or otherwise affect vibration or other dynamic characteristics of the diaphragm assembly.

As shown in FIG. 4, the backing plate 96 may also limit the maximum movement of the central portion 52 of the first diaphragm 24 toward the first cover 34 by engaging a stop surface 110 of the first cover 34. In the implementation shown, the stop surface 110 is formed by one or more surfaces of the cover 34 that are raised or closer to the diaphragm 24 than adjacent portions of the cover. The stop surface 110 is also radially overlapped by the backing plate 96 (with regard to an axis of the backing plate and diaphragm 24 generally). Accordingly, the maximum extent to which the diaphragm 24 can move toward the first cover 34 is limited by engagement of the backing plate 96 with the stop surface 110. This may limit or prevent damage to the diaphragm 24 that might occur if a higher than desired pressure existed within the pressure chamber 18. The higher pressure would tend to displace the central portion 52 of the diaphragm 24 further than desired or intended which might cause tearing or plastic deformation (i.e. stretching beyond the elastic limit of the diaphragm material) of the diaphragm at the outer edge of the backing plate 96 or between the trapped and not trapped portions of the diaphragm 24. Hence, even if the inlet valve 20 fails or breaks, or the contact element 80 breaks such that the inlet valve 20 is not closed, the diaphragm movement is limited by engagement of the backing plate 96 with the stop surface 110 regardless of the pressure that exists within the pressure chamber 18.

Further, outboard of the stop surface 110, a surface 112 of the cover 34 may be within 7 mm (e.g. between 1 mm and 7 mm) of the bottom side of the main body 32 so that the diaphragm outboard of the stop surface 110 and inboard of the main body 32 engages the inside of the first cover 34 before plastic deformation of that portion of the diaphragm 24 occurs. This is best shown in FIG. 4 wherein the diaphragm 24 is shown to be fully engaged with the first cover 34 between the stop surface 110 and the edge of the trapped portion of the diaphragm 24. Hence, the cover provides surfaces 110, 112 engaged by one or both of the backing plate 96 and the diaphragm 24 to limit maximum diaphragm movement in the direction reducing the volume of the reference chamber 56.

In the implementation shown, the pressure regulator 10 includes a second stage of pressure control which may be constructed and operate very similar to or the same as the first stage and hence, the construction and operation of the second stage will not be described in detail. The second stage may include the second diaphragm 30 which may be trapped between the top side 40 of the main body 32 and the second cover 38 in the same way the first diaphragm 24 is trapped between the first cover 34 and the main body 32. The second stage may further include a second reference chamber 122 defined at least in part by the second diaphragm 30 and the second cover 38, and a biasing member 124 may be received between the second diaphragm and the second cover. A second pressure chamber 126 is defined at least in part between the second diaphragm 30 and the main body 32, and a second inlet valve 128 controls admission of pressurized gas from the first pressure chamber 18 through a second inlet passage 130 formed in the main body 32 to the second pressure chamber 126. The second inlet valve 128 includes a valve seat 129, valve head 132 carried by a lever 134 that pivots about a pin 136 received between the valve head 132 and an opposite end of the lever 134 which is selectively acted upon by a contact element 138 carried by the second diaphragm 30 and fixed to a backing plate 140. The second cover 38 may provide a stop surface 142 that engages the backing plate 140 and/or portions of the second diaphragm 30 to limit the extent to which the second diaphragm may move in the direction reducing the volume of the second reference chamber 122. The second pressure chamber 126 is in turn communicated with an outlet passage 144 of the pressure regulator 10 to provide pressurized gas at the threshold pressure established in the second stage of the pressure regulator.

The first stage of the pressure regulator 10 may have a threshold pressure that is greater than the second stage of the pressure regulator to enable better control in reducing the input gas pressure to a desired output gas pressure delivered from the pressure regulator. In one non-limiting example, the threshold pressure of the first stage is 100 kPa. At this pressure, the first inlet valve 20 will be closed by displacement of the central portion 52 of the first diaphragm 24 in a direction and to an extent that causes the contact element 80 to engage the first lever 76 and close the first valve head 72 against the first valve seat 74. In this example, the threshold pressure of the second stage is 5 kPa. At this pressure, the second inlet valve 128 will be closed by displacement of the central portion of the second diaphragm 30 in a direction and to an extent that causes the contact element 138 to engage the second lever 134 and close the second valve head 132 against the second valve seat 129.

The threshold pressure of each stage is determined by the forces acting on the diaphragms 24, 30. For each diaphragm 24, 30, these forces include the force of the gas in the respective pressure chamber 18, 126 (which is a function of the gas pressure and the surface area on which it acts), which is counteracted by the force of the spring 60, 124, the pressure within the reference chamber 56, 122 (which is a function of the pressure therein and the surface area on which it acts) and the force of the gas acting on the valve head 72, 132 within the area of the valve seat 74, 129 (which is a function of the gas pressure and the surface area on which it acts). If diaphragms 24, 30 having similar untrapped surface areas are used in the two stages, the threshold pressure can be conveniently and easily changed by using springs 60, 124 that provide different forces in the two stages. Hence, a maximum number of parts may be the same between the two stages to facilitate assembly and reduce part count, complexity and cost of the pressure regulator 10 while providing two stages having different pressure thresholds.

FIGS. 7 and 8 illustrate an interface between a diaphragm 150 and the body 152 and cover 154 of a pressure regulator 156. The diaphragm 150 may be the same as or similar to the diaphragms 24, 30 discussed above, and in particular, may include an annular bead 158 within a trapped portion of the diaphragm 150. That is, the bead 158 is within the portion of the diaphragm 150 that is overlapped by the main body 152 and cover 154 in assembly. One or both of the main body 152 and cover 154 include a groove in which the bead 158 is at least partially received. In the implementation shown, both the main body 152 and the cover 154 include oppositely facing annular grooves 160, 162 in which portions of the bead 158 are received. Although not necessary, the groove 160 in the main body 152 may be deeper than the groove 162 in the cover 154, at least where there is more material in the main body in which the groove may be formed—the cover usually is a relatively thin component such that a deep groove is not easily formed in the cover.

In at least some implementations, the groove 160 in the main body 152 is formed at an outer diameter that is smaller than the outer diameter of the bead 158. Accordingly, an outer edge 164 of the bead 158 engages a radially outer surface 166 of the groove 160. Further as shown in FIG. 8, to aid in providing a gas-tight seal between the main body 152 and the cover 154, the distance between the base or bottom surface 170 of the groove 160 and the bottom surface 172 of groove 162 is less than the diameter or corresponding dimension of the bead 158 in cross-section (FIG. 8 shows the bead in an uncompressed state—in assembly the bead is compressed flat against the surfaces of the grooves), such that the bead engages and is compressed between the bottom surface 170, 172 of each groove 160, 162. In at least some implementations, to accommodate tolerances in the main body 152, cover 154 and diaphragm 150, the grooves 160, 162 have a width (measured between a radially inner side surface 174, 176 and a radially outer side surface 166, 178 of the grooves 160, 162, where the side surfaces are on opposite sides of the base 170, 172) that is greater than the diameter or width of the bead 158. Thus, the bead 158 may be spaced from the inner side surfaces 174, 176 of the grooves 160, 162 in the main body 152 and cover 154.

When pressurized gas is admitted into the pressure chamber 180, the gas may lead between the radially inner surface of the main body 152 and the diaphragm 150, and enter the groove 160 in the main body 152 and act on the diaphragm 150. This may tend to outwardly displace or compress the bead 158 against the outer side surfaces 166, 178 of the grooves 160, 162 in the main body 152 and cover 154. This compressive force on the bead 158 helps to ensure a gas-tight seal between the diaphragm 150 and main body 152. In at least some implementations, part of the untrapped portion of the diaphragm 150 may wrinkle or buckle when the bead 158 is constrained from outward movement by the outer side surface 166, that is, when the bead's outer diameter is greater than the groove 160 outer diameter. Wrinkling of the diaphragm 150 can vary and make inconsistent a set up or target output pressure of the pressure regulator 156. To alleviate this wrinkling or buckling, the outer side surface 166 of the groove 160 in the main body 152 may include a relieved portion 182 which may provide a wider section of the groove 160 that defines part of the outer side surface 166 of the groove. The relieved portion 182 may have any desired shape and orientation, and in the implementation shown, the relieved section is defined by an outwardly angled portion of the outer side surface 166 of the groove 160. The outwardly angled section may be, for example, in the form of a bevel or chamfer leading from a point 184 between the base 170 and edge 186 of the outer side surface 166 and extending to the edge 186. Hence, the groove 160 is wider at the edge 186 of the outer side surface 166 than it is at a point 184 outboard of the relieved portion 182. In the example shown, the relieved portion 182 starts at about a midpoint of the outer side surface 166 and terminates at the edge 186 of the side surface 166. The increased width provided by the relieved portion 182 accommodates some additional outward movement or compression of the bead 158 so that the untrapped portion of the diaphragm 150 can be more relaxed and without wrinkles to provide more consistent performance and movement of the diaphragm in use, and a consistent and stable set up pressure (with one target output pressure being 4.5 kPa+/−1 kPa). As shown in FIG. 8, the groove 162 in the cover 154 may also be relieved or wider than the portion of the bead 158 received within that groove 162. And the groove 162 in the cover 154 may reduce the height compression of the bead 158 (compared to a cover without any groove) which may also reduce the likelihood that the diaphragm 150 will buckle or wrinkle.

Other diaphragm and groove arrangements may be used, as desired. In a construction and arrangement wherein the radially inner surface of the bead engages the inner surface of the groove, and the groove is wider than the bead, wrinkling of the diaphragm can be avoided (the bead may move toward the outer surface of the groove) but the gas-tight seal might not be robust enough to prevent leakage of gas at higher pressures. This may occur because the bead is engaged with the main body only at the base of the groove and not along its radially outermost surface (relative to an axis of the diaphragm) so there is less surface area of sealing engagement. Further, the cover can be formed without any groove, if desired, and the bead can be compressed generally flat against the cover.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A pressure regulator, comprising:
a first body;
a second body coupled to the first body;
a diaphragm having a portion trapped between the first body and the second body and a not trapped portion that is movable relative to the first body and second body;
a stop surface defined by the second body;
a backing member coupled to the not trapped portion of the diaphragm for movement with the not trapped portion of the diaphragm, wherein the backing member engages the stop surface to limit the amount the not trapped portion of the diaphragm can move toward the second body.

2. The pressure regulator of claim 1 which also includes a biasing member engaged with the second body and the backing member to yieldably bias the diaphragm away from the second body.

3. The pressure regulator of claim 1 wherein the stop surface is arranged so that the backing member engages the stop surface before the diaphragm is plastically deformed.

4. The pressure regulator of claim 1 which also comprises a pressure chamber defined at least in part between the first body and the not trapped portion of the diaphragm, and wherein the first body includes a groove formed in the area of the trapped portion of the diaphragm, and the diaphragm includes a bead received at least partially within the groove.

5. The pressure regulator of claim 4 wherein the groove has an inner side surface, a bottom surface and an outer side surface and the bead is engaged with the bottom surface and the outer side surface.

6. The pressure regulator of claim 5 wherein the main body includes a relieved section that defines a wider portion of the groove at the outer side surface.

7. The pressure regulator of claim 6 wherein the relieved section includes an outwardly angled section of the outer side surface.

8. The pressure regulator of claim 4 wherein the second body includes a groove facing the diaphragm and the bead is at least partially received within the groove in the second body.

9. The pressure regulator of claim 1 wherein the stop surface is an annular surface that is raised or located closer to the diaphragm than portions of the second body adjacent to the stop surface.

10. The pressure regulator of claim 5 wherein the bead has a width that is less than the distance between the inner side surface and the outer side surface and the bead is not engaged with the inner side surface.

11. The pressure regulator of claim 8 wherein the groove in the first body has a bottom surface and the groove in the second body has a bottom surface that faces the opposite direction as the bottom surface of the groove in the first body, and the bead is compressed between the bottom surface of the first groove and the bottom surface of the second groove.

12. A pressure regulator, comprising:
a first body including a groove having an inner side surface, a bottom surface and an outer side surface and the bead is engaged with the bottom surface and the outer side surface;
a second body coupled to the first body;
a diaphragm having a portion trapped between the first body and the second body and a not trapped portion that is movable relative to the first body and second body, the portion trapped between the first body and the second body includes a bead received at least partially within the groove;
a pressure chamber defined at least in part between the first body and the not trapped portion of the diaphragm.

13. The pressure regulator of claim 12 wherein the main body includes a relieved section that defines a wider portion of the groove at the outer side surface.

14. The pressure regulator of claim 13 wherein the relieved section includes an outwardly angled section of the outer side surface.

15. The pressure regulator of claim 12 wherein the second body includes a groove facing the diaphragm and the bead is at least partially received within the groove in the second body.

16. The pressure regulator of claim 15 wherein the groove in the first body has a bottom surface and the groove in the second body has a bottom surface that faces the opposite direction as the bottom surface of the groove in the first body, and the bead is compressed between the bottom surface of the first groove and the bottom surface of the second groove.

17. The pressure regulator of claim 12 wherein the bead has a width that is less than the distance between the inner side surface and the outer side surface and the bead is not engaged with the inner side surface.

18. The pressure regulator of claim 16 wherein the bead has a width that is less than the distance between the inner side surface and the outer side surface and the bead is not engaged with the inner side surface.

19. The pressure regulator of claim 18 wherein at least one of the groove in the first body or the groove in the second body includes a relieved section that defines a wider portion of that groove at the outer side surface.
